(19) United States
(12) Patent Application Publication
(10) Pub. No.: US 2011/0212816 A1
(43) Pub. Date: Sep. 1, 2011

(54) FOLDING DEVICE INCLUDING ONE OR SEVERAL BELT(S) CAPABLE OF PERFORMING A TIMED MOVEMENT BETWEEN TWO POSITIONS

(75) Inventors: Philippe Francois Herda, Nogent Sur Oise (FR); Jerome Jean-Michel Peres, Montataire (FR); Thierry-Bernard Vauchelle, Maignelay Montigny (FR); Thierry Henri Melon, Breuil Le Vert (FR); Jean-Francois Robert, Creil (FR); Eric Pierda, Saint Leu D'Esserent (FR); Franck Chagnon, Saint Leu D'Esserent (FR)

(73) Assignee: GOSS INTERNATIONAL MONTATAIRE SA, Montataire (FR)

(21) Appl. No.: 12/980,997

(22) Filed: Dec. 29, 2010

(30) Foreign Application Priority Data
Dec. 29, 2009 (FR) 09 59652

(51) Int. Cl. B31F 1/30

(52) U.S. Cl. 493/441

(57) ABSTRACT

A folding device including a folding member, and at least one first belt adapted to act in a forwarding plane on a product to be folded in order to position it opposite the folding member, the device including a movement device for moving the or each first belt relative to the forwarding plane between a first position, in which the first belt exerts a first pressure on the product to be folded, and a second position, in which the first belt exerts a second pressure on the product to be folded that is lower than the first pressure.

The movement device is adapted to make the belt alternate between the first and second positions.

This application claims priority to French application FR 09 59652, filed on Dec. 29, 2009, the entire disclosure of which is incorporated by reference herein.

The present invention relates to a folding device:

### BACKGROUND

Such a folding device is known in particular from document FR-2 676 390 A1.

This document describes a folder in which signatures captured between the upper and lower conveyor belts are forwarded by the latter towards a folding table to be folded longways under the action of a folding blade. The upper strands of the lower conveyor belts are supported by stripper rolls 16 that can be jointly or individually moved horizontally. By manually moving the stripper rolls 16, it is possible to vary the incline angle of the upper strands of the lower conveyor belts relative to the surface of the folding table, the aim being to modify the impact intensity of the signatures to be folded and to establish an adaptation to the type of paper and the thickness of the signature.

Nevertheless, it has been noted that with this known solution, braking of the products to be folded and their taking in by the stripper rolls are not always satisfactory, which harms the quality of the folding.

### SUMMARY OF THE INVENTION

An object of the invention is therefore to produce a folding device ensuring improved folding of the products to be folded.

The invention provides a folding member, and at least a first belt adapted to act in a forwarding plane on a product to be folded in order to position it opposite the folding member, the device including a means for moving the or each first belt relative to the forwarding plane between: a first position, in which the first belt exerts a first pressure on the product to be folded, and a second position, in which the first belt exerts a second pressure on the product to be folded that is less than the first pressure. The folding device characterized in that the movement means is adapted to make the belt alternate between the first and second positions.

By providing movement means making the belt alternate between the two positions, it becomes possible to vary the pressure exerted by the belt on the product to be folded during the operation of the folding device. Thus, it is in particular possible to facilitate taking in of the product to be folded by the folding rolls during performance of the fold, reduce crushing of the products to be folded on the stops of the folding table, and improve braking of the products to be folded.

According to other embodiments, the folding device includes one or several of the following features, considered alone or according to all technically possible combinations. The forwarding means of the or each first belt comprises, for each first belt:

a first guide member around which the first belt (d) is guided;

a first mobile support member carrying the first guide member; and

a first means for timed to-and-fro actuation of the first mobile support member, which is adapted to move the first belt (d) between the first (Pb) and second (Ph) positions;

the forwarding means of the or each first belt also comprises, for each first belt:

a second guide member around which the first belt (d) is guided;

a second mobile support member carrying the second guide member; and

a second means for timed to-and-fro actuation of the second mobile support member that is adapted to move the first belt (d) between the first and second positions;

the or each first, or second if applicable, mobile support member is a pivoting lever having a first end, which is an end for positioning the belt relative to the forwarding plane and which carries the associated guide member, and a second end that is pivotably housed;

the means for moving the or each first belt comprises, for each mobile support member, a control lever fixed in rotation to the associated mobile support member and that cooperates with the first or second associated timed actuating means;

the or each first or second timed actuating means comprises a cam or eccentric shaft, a jack or an electromagnet, if applicable the timed actuating means acting on the control lever;

each of the first and second mobile support members forms an end of the first belt, the first and second mobile support members are arranged opposite each other, and acting on the associated end of the first belt, respectively, so as to allow or create a movement of the belt in a direction perpendicular to the forwarding plane;

the first and second timed actuating means comprise a shared actuating member, in particular a shared cam;

the first and second timed actuating means comprise two distinct actuating members, in particular two distinct cams;

the second position is an inclined position of the belt relative to the forwarding plane and the first position is a position where the belt is parallel to the forwarding plane;

the folding device comprises a first additional belt adapted to act in the forwarding plane on the product to be folded in order to position it opposite the folding member;

the means for moving the first additional belt comprises a synchronization means connecting the first mobile support member of the first additional belt to the first mobile support member of the first belt for a synchronous movement of these two support members for synchronous driving of the first belts between the first and second positions;

the or each first belt is a driven belt for forwarding the product to be folded, and in which the first position is a forwarding position of the product to be folded and the second position is a released position of the product to be folded;

the or each first belt is a static belt for braking the product to be folded, and in which the first position is a braking position of the product to be folded and the second position is a withdrawn position of the or each belt;

the folding device comprises a second belt that is either a forwarding belt, or a braking belt, and which is not associated with the movement means of the first belts.

the second pressure is greater than or equal to 0 Pa, and is preferably strictly greater than 0 Pa;

the folding device comprises a cam follower for each mobile support member; each cam follower cooperates with the shared cam;

a first cam follower cooperates with one of the two distinct cams, and a second cam follower cooperates with the other of the two distinct cams;

the folding device comprises a control means capable of adjusting the or each timed actuating means to an actuating frequency Fr such that: Fr=Fa/n, where Fa is the forwarding frequency of the products to be folded, and n is a positive integer;

the movement means is adapted to assume its released position before the folded product abuts against a stop;

the first and second positions are extreme positions;

the device comprises at least one second belt, in particular a driven forwarding belt, and said second belt is the belt closest to the slot.

### BRIEF DESCRIPTION OF THE DRAWINGS

The invention will be better understood upon reading the following description, provided solely as an example, and done in reference to the appended drawings, in which:

FIG. 1 is a top view of a first embodiment of a folding device according to the invention;

FIGS. 2 and 3 are front views of the device of FIG. 1 according to the arrows A illustrating the forwarding and released positions, respectively;

FIGS. 4 and 5 are views similar to those of FIGS. 2 and 3, illustrating a first alternative embodiment of FIG. 1;

FIGS. 6 and 7 are views similar to FIGS. 2 and 3 illustrating a second alternative embodiment of FIG. 1;

FIG. 8 is a top view of a second embodiment of a folding device according to the invention; and

FIGS. 9 and 10 are front views of the embodiment of FIG. 8 according to the arrows A illustrating the withdrawn and braking positions.

### DETAILED DESCRIPTION

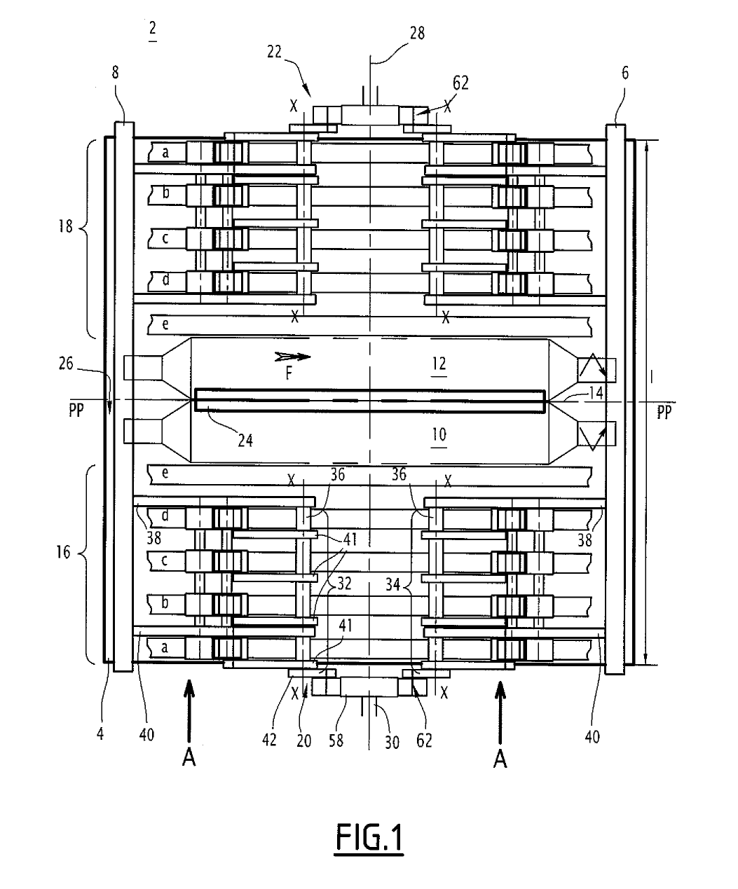

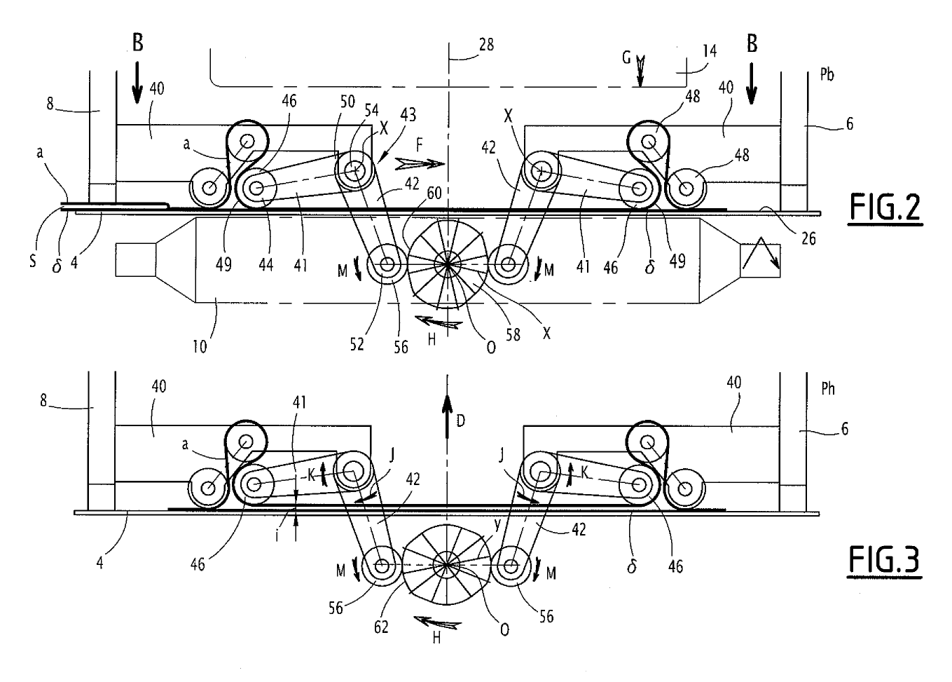

FIG. 1 is a top view according to arrows B of FIG. 2 of a first embodiment of a folding device 2 according to the invention. The folding device 2 is situated downstream from a printing unit and possibly a cutting device from which it receives printed signatures to be folded.

The folding device 2 comprises a folding table 4 with a width 1, first and second frames 6, 8, two folding rolls 10 and 12, a folding blade 14, a set of driven forwarding belts, and means 20, 22 for moving part of the belts relative to the folding table 4.

The folding rolls 10 and 12 are situated below the folding table 4, on either side of a slot 24 formed in the table 4. The folding table 14 is arranged above the table 4 and can be lowered to be inserted in the slot 24. The folding blade 14 defines a folding plane PP extending perpendicularly relative to the folding table 4. Signature stops are arranged near the first frame 6.

The set of driven forwarding belts comprises a first bank 16 of upper belts and an associated bank of lower belts, as well as a second bank 18 of upper belts and associated bank of lower belts. The movement means 20 is connected to the first bank 16, while the movement means 22 is connected to the second bank 18.

The construction and operation of the banks 16 and 18 of upper belts and the movement means 20 and 22 are identical. Indeed, the folding device 2 is a symmetrical construct relative to the folding plane PP. As a result, we will provide a description only of the construction and operation of the bank 16 of upper belts and associated movement means 20.

The bank 16 comprises a set of several upper belts, in this case four belts, designated a, b, c, d, on which the movement means 20 acts, as well as an individual upper belt e provided without movement means.

The belts a to e are driven belts, i.e. driven in circulation. The individual belt e is the belt closest to the slot 24.

Thus, the signature passing in the slot 24 is guided by the belt e and the formation of folds by “backlash” is avoided.

Each upper belt a to d is carried by a total of six pulleys, including four pulleys 48 fastened to supports 38 and 40 connected to the frames 6 and 8, and two mobile pulleys 46 (cf. FIG. 2). Each mobile pulley 46 is pressed against a section 49 of the associated upper belt. Hereinafter, these sections 49 will be described as “ends” of the upper belt.

FIGS. 2 and 3 show a lower belt 5 of the bank of lower belts connected to the bank 16 of upper belts. Each of the upper belts a to e is associated with such a corresponding lower belt.

The movement means 20 is adapted to move the upper belts a to d relative to a forwarding plane 26 defined by the folding table 4 between a first low position Pb (cf. FIG. 2) and a second high position Ph (cf. FIG. 3). The movement means 20 is built symmetrically relative to a vertical median plane 28 perpendicular to the folding plane PP and the forwarding plane 26. The movement means 20 comprises a single cam shaft 30 provided with a cam 58 that interacts, on each side of the plane 28, with a pivoting assembly 32, 34.

The cam 58 is generally elliptical in shape with a center O, a small axis x and a large axis y. The surface of the cam 58 is divided into surface sections 60 close to the center O and surface sections 62 far from the center O.

Each pivoting assembly 32, 34 includes a rod 36 housed around a pivot axis X-X pivoting in the two supports 38 and 40. Each pivoting assembly 32, 34 includes a set of four support levers 41 and a control lever 42.

Each support lever 41 has a first end 50 secured in rotation to the pivoting rod 36. Each support lever 41 has a pivot axis 54 at the first end 50 that coincides with the pivot axis X-X. Each support lever 41 also has a second end 44 provided with one of the mobile pulleys 46 (cf. FIG. 2). Each mobile pulley 46 is used to guide and position the associated upper belt a, b, c, d relative to the forwarding plane 26.

The control lever 42 differs from the support levers 41 by its orientation. The control lever 42 forms an obtuse angle with the support levers 41.

The control lever 42 includes a first end 43 with which it is rotatably secured to the rod 36. The control lever 42 has a pivot axis 54 at the first end 43 that coincides with that of the support levers 41 and with the pivot axis X-X.

The control lever 42 cooperates with the cam shaft 30. More specifically, the control lever 42 includes a second end 52 opposite the first end 43 that is provided with a cam roller or follower 56 in contact with the cam 58 of the cam shaft 30.

The roller 56 of the control lever 42 of each pivoting assembly 32, 34 cooperates with the same cam 58. The cam 58 is therefore a cam shared by the two rollers 56.

Each roller 56 is stressed towards the surface of the cam 58 by spring elements. These may in particular be compression springs or torsion rods.

We will now describe the operation of the first embodiment of the folding device 2 according to the invention in reference to FIGS. 1 to 3.

Products to be folded, i.e. printed signatures, are forwarded towards the device 2 to undergo square folding. The forwarding direction of the signatures on the folding table 4 is indicated in FIG. 2 by the arrow F. Each signature has a width, i.e. a transverse direction perpendicular to the forwarding direction F and parallel to the forwarding plane 26, that is substantially equal to the width I (cf. FIG. 1) of the folding table 4.

The journey of a copy signature S, shown at the extreme left of FIG. 2, inside the folding device 2 is as follows. Along its width, the signature S is grasped between the banks 16 and 18 of upper belts a to e and the corresponding banks of lower belts. The upper and lower belts are driven in the forwarding direction F in order to forward the signature S on the folding table 4, below and opposite the folding blade 14. The signature S is immobilized on the folding table 4 using stops situated on the frame side 6. Once the signature S is immobilized, the folding blade 14 lowers along the arrow G shown in FIG. 2. The median zone of the signature S is pushed through the slot 24 by the action of the edge of the folding blade 14 to then be taken in by the rotating folding rolls 10 and 12. The signature S thus undergoes a resulting folding in a so-called “square fold.”

Owing to the cadenced movement means 20, 22 according to the invention, the upper belts a to d move several millimeters away from the lower belts upon each passage of the signature S before the signature S has been immobilized, in particular by the stops, and before it is engaged by the blade 14 in the slot 24 of the table 4.

FIG. 2 shows a signature S at the beginning of forwarding by the belts towards the folding table 4. The upper belt is in the low position Pb and exerts a first forwarding pressure P1 on the signature S that is sufficient to drive it in the direction of the arrow F. The signature S is therefore gripped between the upper belt a and the lower belt δ. The low position Pb of the upper belt a is defined by the size of the small axis x of the cam 58. Indeed, in the low position Pb, the rollers 56 of the control levers 42 are in contact with the surface sections 60 of the cam 58. The control levers 42 are then in the retracted position as illustrated in FIG. 2. The mobile pulleys 46 attached to the support levers 41 are in the low position and press the upper belt a against the surface of the signature S.

The signature S is forwarded by the belts in the forwarding direction F towards the folding position. During that time, the cam 58 rotates following the arrow H indicated in FIG. 2. When the signature S is about to abut against the stops, the cam 58 has performed about a quarter revolution to arrive at the position indicated in FIG. 3. The rollers 56 of the control levers 42 have rolled on the cam surface (cf. arrows M) and are then in contact with the surface sections 62 of the cam 58. This rotational movement of the cam 58 creates a spacing of the control levers 42 towards a maximum spaced position defined by the large axis y of the cam 58. As a result, the control levers 42 move following the arrow J shown in FIG. 3, i.e. outwards and downwards. The control levers 42 drive the rods 36 and thus the support levers 41, as indicated by the arrows K. A movement of the mobile pulleys 46 follows, and thus a raising of the upper belt a in the direction D indicated in FIG. 3. A gap i of several millimeters is thus created between the upper belt a and the lower belt δ. The upper belt is then in a released position where it exerts a second pressure P2 on the signature S that is lower than the forwarding pressure P1. The second pressure P2 can even be equal to 0 Pa, the upper belts then being, in the released position Ph, not in contact with the signature S.

More generally, the second pressure P2 is greater than or equal to 0 Pa, and is preferably strictly greater than 0 Pa.

The signature S is thus not relieved much before producing the square fold. This has the advantage of reducing crushing of the signature S on the stops and facilitating taking in of the signature S by the rolls 10 and 12. Indeed, owing to the gap i, the ends of the signature S are more easily withdrawn from the banks of forwarding belts.

Releasing the signature S is preferably done before said signature S abuts against the stops. Thus the crushing of the signature on the stops is reduced.

The cam shaft 30 is driven so as to obtain lifting of the upper belts for each signature S to be folded. Thus, the upper belts a to d perform an alternating movement between the two positions Pb and Ph shown in FIGS. 2 and 3.

The rotation of the cam shaft 30 is adjusted by a control means to a frequency Fᵣ that is substantially equal to half the forwarding frequency of the signatures S.

The use of a generally elliptical cam as shown in FIGS. 2 and 3 is not limiting. A cam can be considered having a different shape, or even an eccentric, the frequency of rotation Fᵣ then having to be adapted to the shape of the cam or eccentric chosen. More generally, the frequency Fᵣ can be such that Fᵣ is equal to Fₐ/n where Fₐ is the forwarding frequency of the signatures S, and n is a positive integer.

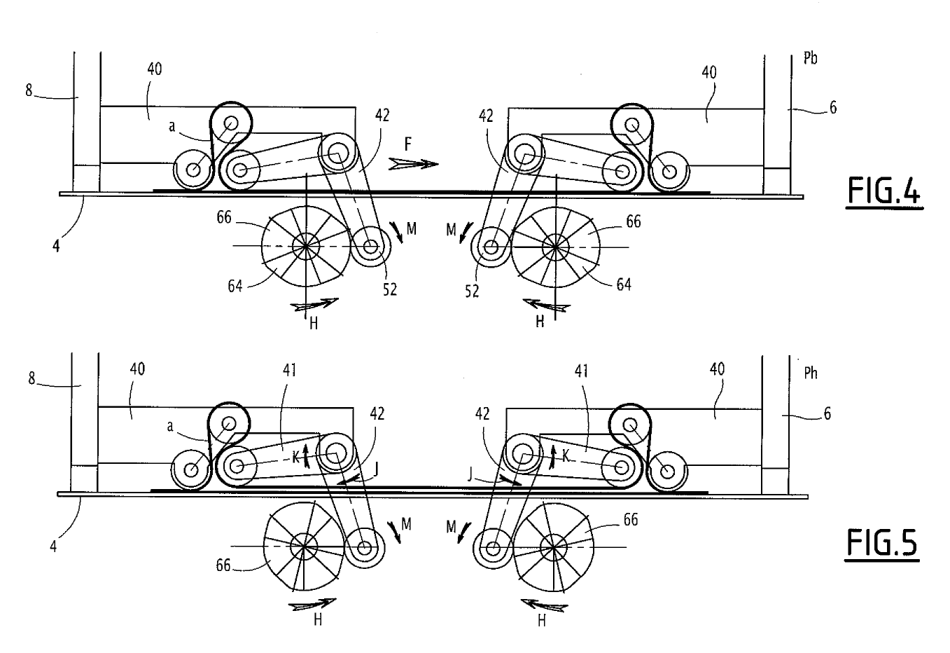

FIGS. 4 and 5 show a first alternative of the first embodiment of the folding device. This alternative differs from the folding device previously described as follows. In this alternative, the sole shaft 30 has been replaced by two cam 66 shafts 64 each acting on one of the control levers 42. Unlike FIGS. 2 and 3, where the shared cam 58 is situated between the two control levers 42, it is the ends 52 of the control levers 42 that are situated between the two cams 66. The two cams 66 rotate at the same frequency, i.e. are synchronized, in the opposite direction, as indicated by the arrows H. FIG. 4, like FIG. 2, shows the low position Pb, while FIG. 5, like FIG. 3, shows the high position Ph.

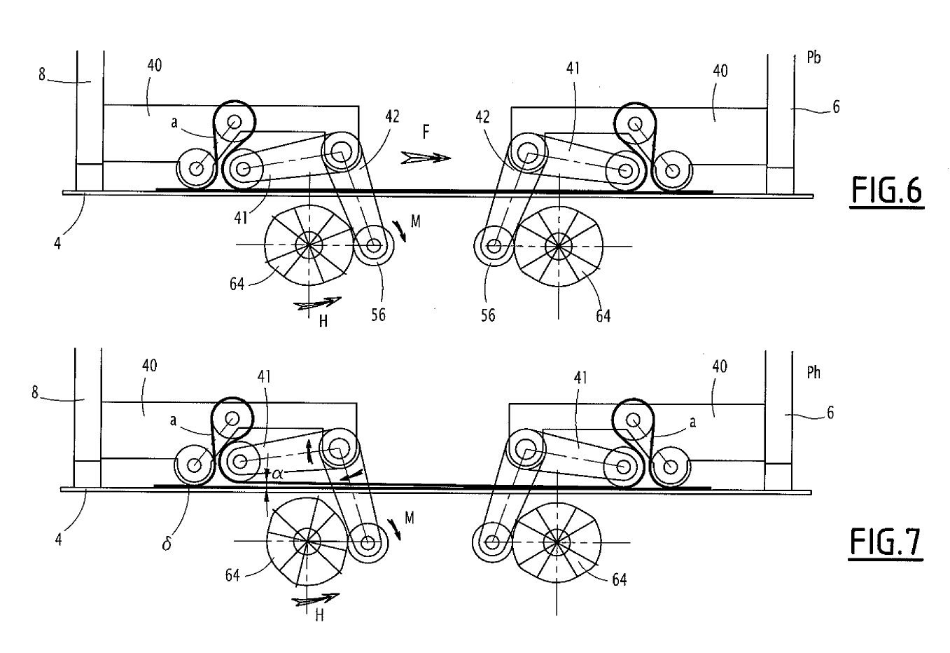

FIGS. 6 and 7 illustrate a second alternative similar to that of FIGS. 4 and 5, differing only in that one of the two shafts 64 is immobilized. The low position Pb of FIG. 6 is identical to that of FIG. 4. However, as illustrated in FIG. 7, with a single rotating shaft 64, the upper belt a only rises on a single side along an angle α relative to the folding table 4. Thus, in the high position Ph, the upper belt a is inclined relative to the forwarding plane.

In the illustrated case, the belt is inclined such that it is raised on a head side of the signature, therefore towards the downstream of the forwarding direction F.

Alternatively, in the position Ph, the belt is inclined relative to the table 4 such that it is raised on a tail side of the signature, therefore towards the upstream of the forwarding direction F.

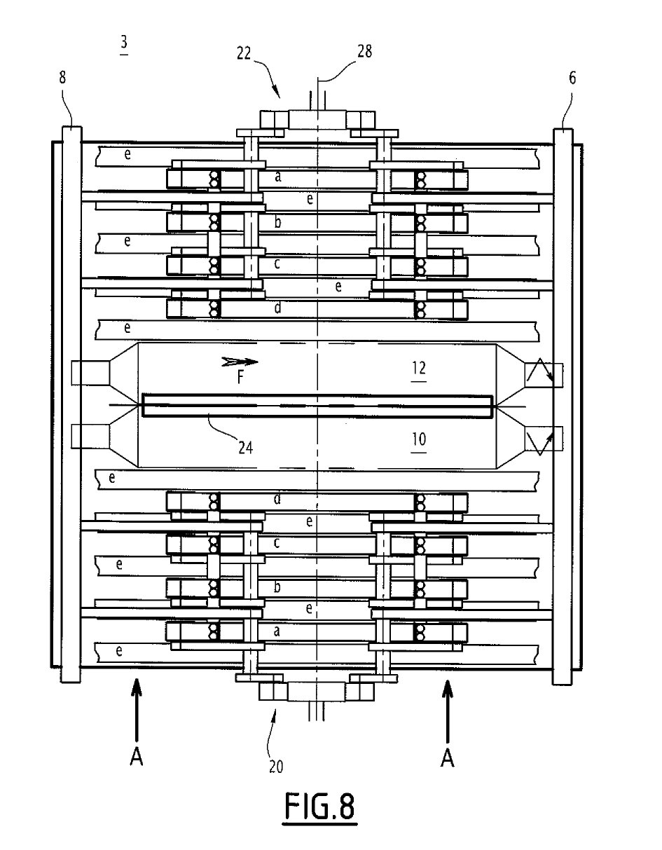

FIGS. 8 to 10 show a second embodiment 3 of a folding device according to the invention. This second embodiment is identical to the first regarding its means 20 and 22 for moving two sets of upper belts a to d. However, in this embodiment, the upper belts, which are lowered and raised in a timed manner, are not belts for forwarding a signature, but additional static braking belts. The additional upper belts a to d are not driven and are fixed at their ends 68 using screws 70 to the supports 38, 40. The additional upper braking belts a to d are housed between upper e and lower 6 forwarding belts.

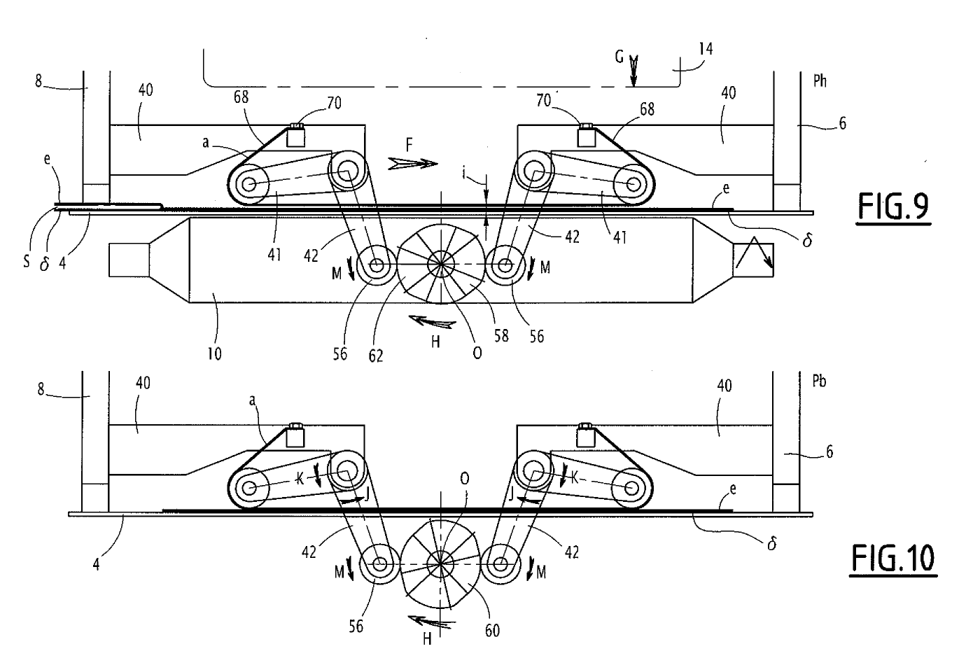

The second embodiment 3 of the folding device according to the invention operates as follows. In reference to FIG. 9, a signature S is forwarded by the forwarding belts e, δ on the folding table 4 in the direction indicated by the arrow F. At the beginning of forwarding, the upper braking belt a is in a high position Ph and height offset relative to the forwarding belts e, by a gap i in the vicinity of several millimeters. The rollers 56 are in contact with the surface sections 62 of the cam 58 such that the two control levers 42 are in the separated position. While the signature S continues its path on the folding table 4, in the forwarding direction F, the cam 58 continues to rotate until it reaches the position illustrated in FIG. 10. In this position, the rollers 56 that follow the cam surface are in contact with the surface 60 of the cam 58. Thus, the control levers 42 pivot upwards and one towards the other as indicated by the arrows J to reach a refracted position, lowering the upper braking belt a.

The frequency of rotation of the cam shaft 30 as well as its phase are adjusted such that the upper braking belts a to d lower upon each passage of a signature S to brake it before it is engaged by the folding blade 14 in the slot 24 of the folding table 4, then taken in by the folding rolls 10, 12. By descending towards the signature S in motion, the upper braking belts a to d come into contact with the latter so as to brake it through friction. During braking, the cam 58 continues to rotate until it again reaches the position shown in FIG. 9. The upper braking belts are raised, the signature S is folded and the cycle starts again. The frequency Fᵣ of rotation of the cam shaft 30 is adjusted such that Fᵣ is equal to Fₐ/n, where Fₐ is the forwarding frequency of the products to be folded, and n is a positive integer.

The two embodiments, i.e. a timed system for raising forwarding belts and a braking system through timed lowering of a bank of braking belts, have been described separately. However, these two systems may be combined.

Moreover, the means 20, 22 for timed movement of the belts described above can also be completely situated below the folding table. Moreover, the principles developed above can also be applied to the lower forwarding belts. It is then the lower belts S that are moved in a timed manner and no longer the upper belts.

The movement means 20, 22 can also be modified to move a number of belts different from that of the described embodiments. In reference to FIG. 1, it is for example possible to lengthen the rods 36 up to the belts e and to provide additional support levers 41 enabling timed raising of the belts e together with the belts a to d. Conversely, it is also possible to modify the movement means 20, 22 in order to limit the timed movement for example only to belts a and b. Other alternatives can be considered depending on the desired application.

Of course, the levers 41, 42 can be actuated by means other than cam shafts. The cam shafts can for example be replaced by jacks or electromagnets.

What is claimed is:

1. A folding device comprising:
a folding member;
at least one first belt adapted to act in a forwarding plane on a product to be folded in order to position the product opposite the folding member; and
a movement device for moving the at least one first belt being relative to the forwarding plane between a first position, in which the at least one first belt exerts a first pressure on the product to be folded, and a second position, in which the first belt exerts a second pressure on the product to be folded that is less than the first pressure,
wherein the movement device is adapted to make the first belt alternate between the first position and the second position.

2. The folding device according to claim 1 wherein the movement device of the at least one first belt comprises, for each first belt:
a first guide member around which the first belt is guided;
a first mobile support member carrying the first guide member; and
a first timed actuating device for timed to-and-fro actuation of the first mobile support member, the first mobile support member being adapted to move the first belt between the first position and the second position.

3. The folding device according to claim 2 wherein the movement device of the at least one first belt further comprises, for each first belt:
a second guide member around which the first belt is guided;
a second mobile support member carrying the second guide member; and
a second timed actuating device for timed to-and-fro actuation of the second mobile support member, the second mobile support member being adapted to move the first belt between the first position and the second position.

4. The folding device according to claim 3 wherein the first mobile support member or the second mobile support member is a pivoting lever having a first end, the first end being an end for positioning the first belt relative to the forwarding plane and carrying the associated first or second guide member respectively, and a second end being pivotably housed.

5. The folding device according to claim 2 wherein the movement device for moving the at least one first belt comprises, for each mobile support member, a control lever fixed in rotation to the associated mobile support member and cooperating with the first or second associated timed actuating device.

6. The folding device according to claim 3 wherein the first or second timed actuating device comprises one of a cam or eccentric shaft, a jack or an electromagnet.

7. The folding device according to claim 3 wherein each of the first and second mobile support members forms an end of the first belt, the first and second mobile support members being arranged opposite each other and acting on the associated end of the first belt, respectively, so as to allow or create a movement of the first belt in a direction perpendicular to the forwarding plane.

8. The folding device according to claim 3 wherein the first and second timed actuating device comprise a shared actuating member.

9. The folding device according to claim 3 wherein the first and second timed actuating device comprise two distinct actuating members.

10. The folding device according to claim 1 wherein the second position is an inclined position of the first belt relative to the forwarding plane and the first position is a position where the first belt is parallel to the forwarding plane.

11. The folding device according to claim 1 further comprising a first additional belt adapted to act in the forwarding plane on the product to be folded, positioning the product opposite the folding member.

12. The folding device according to claim 11 wherein the movement device for moving the first additional belt comprises a synchronization device connecting the first mobile support member of the first additional belt to the first mobile support member of the first belt for a synchronous movement of the two support members for synchronous driving of the first additional belt and the first belt between the first position and the second position.

13. The folding device according to claim 1 wherein the at least one first belt is a driven belt for forwarding the product to be folded, the first position being a forwarding position of the product to be folded and the second position being a released position of the product to be folded.

14. The folding device according to claim 1 wherein the at least one first belt is a static belt for braking the product to be folded, the first position being a braking position of the product to be folded and the second position being a withdrawn position of the at least one first belt.

15. The folding device according to claim 11 further comprising at least one second belt, the second belt being either a forwarding belt or a braking belt, the at least one second belt not being associated with the movement device of the first additional belt and the first belt.

16. The folding device according to claim 6 wherein the first or second timed actuating device acts on a control lever.

17. The folding device according to claim 8 wherein the shared actuating member is a shared cam.

18. The folding device according to claim 9 wherein the two distinct actuating members are two distinct cams.
